(19) United States
(12) Patent Application Publication
(10) Pub. No.: US 2008/0070569 A1
(43) Pub. Date: Mar. 20, 2008

(54) PROXIMITY ORDER PROCESSING SYSTEM

(76) Inventors: John T. Shelley, Fort Payne, AL (US); Aaron M. Shelley, Ringgold, GA (US); Adam M. Engesath, Chattanooga, TN (US); James T. Nelson, Rainsville, AL (US); Mark L. Robinson, Chattanooga, TN (US)

Correspondence Address: LUEDEKA, NEELY & GRAHAM, P.C., P O BOX 1871, KNOXVILLE, TN, 37901, US

(21) Appl. No.: 11/470,846

(22) Filed: Sep. 7, 2006

(51) Int. Cl. H04Q 7/20

(52) U.S. Cl. 455/426.2

(57) ABSTRACT

A proximity-based order processing system provides a way for a customer of a restaurant or other retail establishment to set up a default order for food or other goods or services via a web page interface. The customer is issued a portable wireless communication device, such as an active RFID device, having an order-confirmation button. If the button is pressed while the portable unit is in range of a reader unit in the retail establishment, the portable unit transmits an order confirmation signal to the reader unit. Upon receipt of the order confirmation signal, a order handling computer system confirms that a default order on file for the customer and sufficient funds are available in the user's monetary account. If the default order is on file and the funds are sufficient, the customer's order is processed and made ready for pickup. In this manner, the customer need not stand in line to wait to place or pay for an order.

### FIELD

This invention relates to the use of radio frequency identification (RFID) tag devices to place orders for food or other consumer goods or services based on proximity of the tag to a retail establishment. More particularly, this invention relates to a proximity-based ordering system that enables virtually instantaneous placement of customer orders at restaurants and other retailers.

### BACKGROUND

In today's fast-paced world, customers of fast food restaurants and coffee shops do not want to spend time standing in line to place their orders, particularly when the customers know what they want to order even before entering the restaurant. In these situations, it is desirable to have a “standing order” that would be ready and waiting for pick up when the customer walks into the establishment. Even in situations where orders can be placed ahead of time, such as orders placed via telephone, customers do not want to have to wait in line to pay for their orders when they pick them up.

What is needed, therefore, is a system that allows a consumer to establish a standing or default order for a retail establishment, to place the order based on the consumer's proximity to the establishment, and to pay for and pick up the order without having to wait in line or interact with a cashier.

### SUMMARY

The above and other needs are met by a proximity order processing system which comprises a wireless portable communication unit and an order handling system. In a preferred embodiment, the wireless portable communication unit includes a memory device for storing unit information and a communication unit transmitter for transmitting an order confirmation signal that contains the unit information. The wireless portable communication unit also includes an order confirmation input device which is operable by a user to initiate transmission of the order confirmation signal by the communication unit transmitter. The order handling system of the preferred embodiment includes one or more order handling receivers, a database, one or more computer processors and an order placement interface. The order handling receivers receive the order confirmation signal containing the unit information transmitted by the wireless portable communication unit. The database associates the unit information with default order information. The computer processors operate on the database to access default order information associated with the unit information contained in the order confirmation signal. The order placement interface communicates the default order information to an order placement apparatus associated with an order fulfillment establishment, such as a fast-food restaurant, coffee shop or pharmacy.

In a preferred embodiment, the wireless portable communication unit also includes a communication unit receiver and a user feedback device. The communication unit receiver receives user feedback signals from the order handling system, and the user feedback device communicates user feedback to a user of the wireless portable communication unit, where the user feedback is based on characteristics of the user feedback signals. The order handling system of this embodiment further comprises one or more order handling transmitters for transmitting the user feedback signals. The user feedback signals preferably include an in-range feedback signal to indicate when the communication unit transmitter is in communication range of an order handling receiver, an order-placed feedback signal to indicate when the default order information has been provided to the order placement apparatus, and an error feedback signal to indicate when an error has occurred during processing of the user's default order.

In some preferred embodiments, the one or more order handling receivers are disposed in the order fulfillment establishment, the database is located remotely from the order fulfillment establishment, and the computer processors of the order handling system submit database queries via a communication network.

In another aspect, the invention provides a wireless portable communication unit for use in conjunction with a proximity order handling system. In preferred embodiments of the invention, the wireless portable communication unit comprises a memory device, a communication unit transmitter, an order confirmation input device, a communication unit receiver and a user feedback device. The memory device is for storing unit identification information and order confirmation information. The communication unit transmitter is for automatically transmitting an identification signal at periodic time intervals, where the identification signal contains the identification information. The communication unit transmitter is also for transmitting a order confirmation signal when manually activated to do so, where the order confirmation signal contains the order confirmation information. The order confirmation input device is operable by a user to initiate transmission of the order confirmation signal from the communication unit transmitter. The communication unit receiver is for receiving user feedback signals transmitted from the proximity order handling system. The user feedback device is for communicating user feedback to the user of the wireless portable communication unit, where the user feedback is based on characteristics of the user feedback signals.

In yet another aspect, the invention provides a method for placing a predetermined order for goods or services using a portable wireless communication unit, where the goods or services are to be provided by an order fulfillment establishment. In a preferred embodiment, the method includes the following steps:
automatically transmitting a unit identification signal from the portable wireless communication unit at periodic time intervals, where the unit identification signal contains unit identification information;
receiving the unit identification signal at a reader unit associated with the order fulfillment establishment;
extracting the unit identification information from the unit identification signal received by the reader unit;
transmitting a feedback signal from the reader unit to the portable wireless communication unit, where the feedback signal contains feedback information related to the predetermined order;
activating a user feedback device on the portable wireless communication unit based on the feedback information to provide feedback regarding the status of the order;
operating a user input device on the portable wireless communication unit to initiate transmission of an order confirmation signal containing order confirmation information;
transmitting the order confirmation signal from the portable wireless communication unit;
receiving the order confirmation signal at the reader unit associated with the retail establishment;
extracting the order confirmation information from the order confirmation signal received by the reader unit;
determining whether the order confirmation information is associated with registration information stored in a central database, where the registration information identifies the portable wireless communication unit;
determining the predetermined order based at least in part on the order confirmation information extracted from the order confirmation signal; and
communicating the predetermined order to an order placement apparatus associated with the order fulfillment establishment if the order confirmation information is associated with the registration information stored in the central database.

In these and other preferred embodiments of the invention, a consumer is issued a wireless portable communication unit, such as a radio frequency identification (RFID) device, in which two unique unit numbers are stored. The unit numbers are associated with certain customer information in a central customer database. The customer information may include a preferred or default order and payment information. In a preferred embodiment, the wireless device is packaged as a key fob equipped with a push button or other activation device which is used by the customer to confirm placement of the default order. The key fob may also include LED indicator lights which provide feedback to the customer about the status of the ordering process. Preferred embodiments of the system also include one or more RFID reader units networked with a site coordinator computer installed in the restaurant or other retail establishment. The site coordinator computer is interfaced with the restaurant's point-of-sale (POS) order processing computer system, and also is in communication with the central customer database via the Internet.

The wireless portable communication unit is preferably an “active” device which automatically and continuously transmits the unit identification number at periodic time intervals. When the portable unit is within reception range of the reader unit in the restaurant, the reader unit receives the unit identification number transmitted from the portable device. If the unit identification number is valid, the restaurant unit transmits a feedback signal to the portable device indicating that the device is in communication range and has been recognized by the restaurant system. This feedback signal causes an indicator, such as a purple LED, to be activated on the portable device. At any time thereafter, the consumer may press a button on the portable device to place and pay for the default order. When the button is pressed, the portable device transmits a signal containing an order confirmation number. Upon receipt of this signal, the restaurant system verifies the validity of the order confirmation number in the central customer database. If a default order is on record and funds are available in the customer's monetary account, then the customer's order is queued at the restaurant. In this case, a feedback signal is transmitted from the restaurant to the portable device indicating that the order has been successfully placed. This feedback signal causes an indicator, such as a solid green LED, to be activated on the portable device. When the customer's order is ready, the restaurant system transmits another feedback signal to the portable device indicating that the order may be picked up. This feedback signal causes an indicator, such as a flashing green LED, to be activated on the portable device.

If the customer does not have a default order stored in the central database or there are insufficient funds in the customer's account, the reader unit in the restaurant transmits a “negative feedback” signal to the customer's portable device. Upon receipt of the “negative feedback” signal, a red LED on the portable device is illuminated. If the customer receives “negative feedback,” the customer may use a customer interface unit in the restaurant to access the customer's account via the Internet. In this way, the customer may transfer funds to the monetary account and/or enter a default order.

In some embodiments of the invention, the portable communication device, including the order confirmation button and the positive/negative feedback indicators, are integrated into portable electronic devices such as cell phones and PDAs.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts a functional block diagram of a proximity order processing system according to a preferred embodiment of the invention;

FIG. 2 depicts a functional block diagram of a wireless portable communication unit of a proximity order processing system according to a preferred embodiment of the invention;

FIGS. 3A and 3B depict top and side views of a preferred embodiment of a wireless portable communication unit;

FIG. 4 depicts a functional block diagram of a reader unit of a proximity order processing system according to a preferred embodiment of the invention;

FIG. 5 depicts a functional block diagram of a site coordinator computer system of a proximity order processing system according to a preferred embodiment of the invention;

FIG. 6 depicts a functional block diagram of a customer interface unit of a proximity order processing system according to a preferred embodiment of the invention;

FIG. 7 depicts a method of processing an order using a proximity order processing system according to a preferred embodiment of the invention;

FIG. 8 depicts a method of processing user feedback signals in a wireless portable communication unit of a proximity order processing system according to a preferred embodiment of the invention; and

FIGS. 9A-9D depict examples of web pages used in viewing and entering user account information in a proximity order processing system according to a preferred embodiment of the invention.

### DETAILED DESCRIPTION

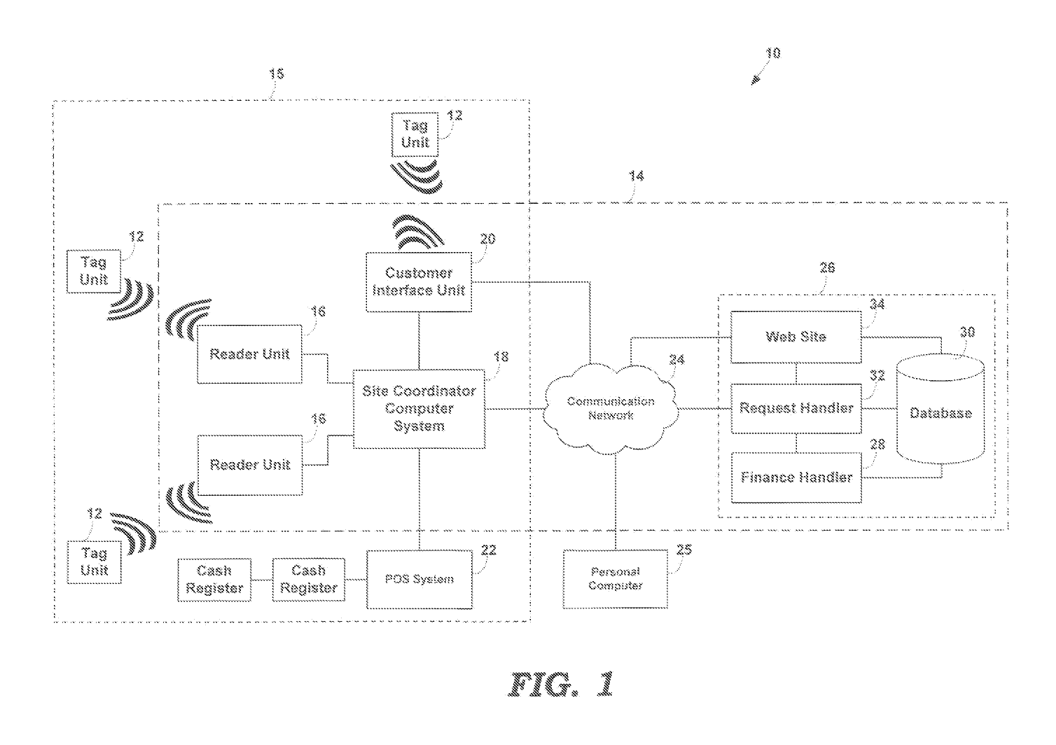

A preferred embodiment of a proximity order processing system 10 is depicted in FIG. 1. Generally, the system 10 consists of a portable wireless communication unit 12 that may be carried by a user and an order handling system 14 that communicates with the portable unit 12. As described in more detail below, some of the components of the order handling system 14 are disposed in a retail establishment 15 and some are disposed at a central location as part of a central server system 26. The portion of the order handling system 14 in the retail establishment 15 communicates with the portion in the central server system 26 via a wide area communication network 24, such as a virtual private network (VPN) established over the Internet.

At the retail establishment 15, the preferred embodiment of the order handling system 14 includes one or more reader units 16, a site coordinator computer system 18 and a customer interface unit 20. At the central location, the preferred embodiment of the central server system 26 includes a finance handler server 28, a customer database 30, a request handler server 32 and a web site server 34. Each of these system components are described in more detail below.

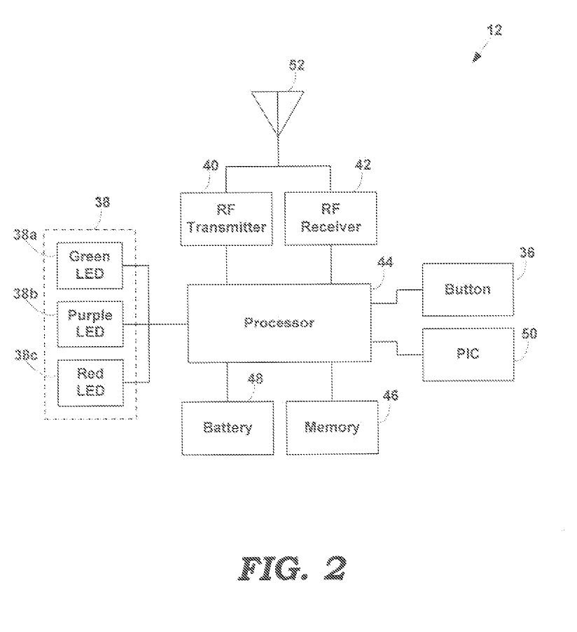

FIG. 2 depicts a functional block diagram of the wireless portable communication unit 12 which is also referred to herein as a tag unit. In a preferred embodiment, the tag unit 12 is an active radio frequency identification (RFID) device having a communication unit transmitter 40 and a communication unit receiver 42 which operate at one or more RF frequencies, such as 868 MHz, 916 MHz and 2.4 GHz. Transmissions to and from the tag unit 12 are provided via an antenna 52 which is coupled to the RF transmitter 40 and RF receiver 42. The tag unit 12 includes a processor 44, such as a model PIC12F683 chip manufactured by Microchip, for processing signals received by the RF receiver 42 and for generating signals for transmission from the RF transmitter 40. The processor 44 has access to memory 46, which may include ROM and RAM memory devices. As discussed in more detail below, the memory 46 stores data strings that contain a site code, a tag identification code and an order confirmation code. The processor 44 may receive programming updates and other data through a serial interface port 50, also referred to herein as a PIC 50. The preferred embodiment of the tag unit 12 is powered by a battery 48, such as a rechargeable lithium-ion battery or replaceable alkaline battery.

The tag unit 12 includes an order confirmation input device 36 which in a preferred embodiment comprises a push-button activated switch that is operable by a user of the tag unit 12. In alternative embodiments of the invention, the input device 36 may comprise a touch pad device, a touch screen device or a voice-activated input device. The purpose and function of the input device 36 is described in more detail hereinafter.

In the preferred embodiment depicted in FIG. 2, the tag unit 12 includes a user feedback device 38 for providing indications to a user regarding the operational status of the unit 12 and status of orders placed using the unit 12. In the embodiment of FIG. 2, the user feedback device 38 comprises three light-emitting diode (LED) devices 38a, 38b and 38c, which are green, purple and red, respectively. The status of the user feedback device 38 is controlled by signals from the processor 44 as set forth in further detail below.

Before a tag unit 12 is used for the first time, its transmitter 40, receiver 42 and user feedback device 38 are inoperative to conserve battery power. Before a tag unit 12 may be used for the first time, it is activated by pressing the button 36 down for about five seconds. This “wakes up” the tag unit 12 to begin processing signals in the system 10.

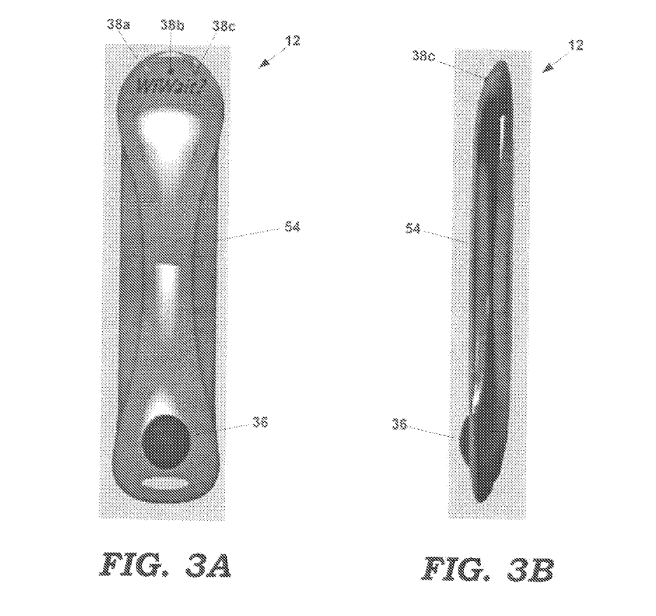

The physical configuration of one preferred embodiment of the tag unit 12 is depicted in FIGS. 3A and 3B. In this embodiment, the user input device 36 comprises a button disposed a one end of an elongate housing 54 and the user feedback device 38 comprises the three LEDs 38a-38c disposed at the opposing end of the housing 54. In this preferred embodiment, the housing 54 is constructed of high-impact thermoplastic in an ergonomic shape for ease of gripping in one hand, and has dimensions of about 2.4 inches by 1 inch by 0.3 inch. Preferably the housing 54 has a hole through it to allow attachment to a key ring.

In an alternative embodiment, the tag unit 12 is housed in a cellular phone. In this embodiment, the input device 36 comprises a button on the phone. Alternatively, the input device 36 may comprise a microphone on the phone which receives a specific spoken user command to activate the input device 36. The user feedback device 38 of the cellular phone embodiment may comprise an LCD display screen on the phone, a vibration unit in the phone or a speaker or other sound generation device for producing distinctive sounds associated with functions of the tag unit 12. Alternatively, the user feedback device 38 may comprise LEDs or other light emitting devices on the housing of the phone.

In another alternative embodiment, the tag unit 12 is housed in a personal digital assistant (PDA) or other handheld computer device. In this embodiment, the input device 36 comprises a button on a keypad, a touchpad or a microphone which receives a spoken command to activate the input device 36. The user feedback device 38 of the PDA embodiment may comprise an LCD or other type of display screen, a vibration device, a sound generation device or LEDs or other light emitting devices integrated into the housing.

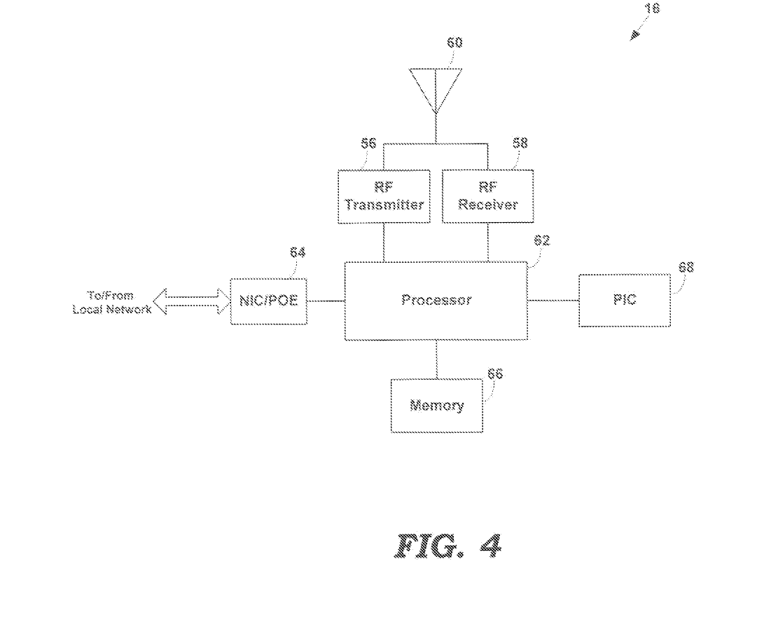

A preferred embodiment of a reader unit 16 is depicted in FIG. 4. This communication device 16 is referred to as a “reader” based on its function of “reading” an RFID tag. The reader unit 16, which is also referred to herein as an order-handling communication unit, provides an RF communication interface between the tag unit 12 and the site coordinator computer system 18. The preferred embodiment of the reader unit 16 includes a reader unit transmitter 56 and a reader unit receiver 58 which operate at one or more RF frequencies, such as 868 MHz, 916 MHz and 2.4 GHz, corresponding to the operational frequency of the tag unit 12. The reader unit transmitter 56 and reader unit receiver 58 are also referred to herein as the order handling transmitter and order handling receiver. Transmissions to and from the reader unit 16 are provided via an antenna 60 which is coupled to the RF transmitter 56 and RF receiver 58. The reader unit 16 includes a processor 62, such as a model TWS-434 chip manufactured by Reynolds Electronics, for processing signals received by the RF receiver 58 and generating signals for transmission from the RF transmitter 56. The processor 62 has access to memory 66, which may include ROM and RAM memory devices. The processor 62 may receive programming updates and other data through a serial interface port 68, also referred to herein as a PIC 68. The preferred embodiment of the reader unit 16 also includes a network interface card 64 for interfacing with a local area network (LAN), such as an Ethernet network. Power for the reader unit 16 is preferably provided via the interface card 64 using power-over-Ethernet (POE) technology.

As shown in FIG. 1, the order handling system 14 may include more than one reader unit 16, depending on the physical layout of the retail establishment 15. For example, one reader unit 16 of an establishment 15 may be operable to communicate with tag units 12 that are inside the establishment 15, and another reader unit 16 may be operable to communicate with tag units 12 in the parking lot of the establishment. Some establishments 15 may have a reader unit 16 dedicated to a drive-through lane. It is anticipated that in some situations, there may be neighboring retail establishments 15 that have order handling systems 14 as described herein. In such situations, the reader units 16 of each establishment 15 are configured to communicate with portable units 12 only within a limited area in or around an establishment so that they do not interfere with reader units 16 of neighboring establishments. This selective communication capability may be enabled by the use of a directional antenna 60 on the reader unit 16 or limited transmitter power or both.

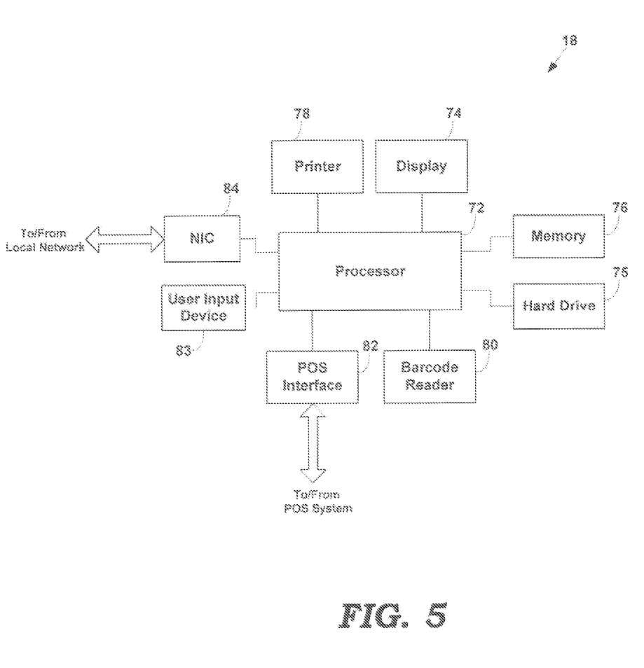

A preferred embodiment of the site coordinator computer system 18 is depicted in FIG. 5. The system 18 includes a processor 72, such as a model D Pentium 805 Dual Core 2.66 GHz processor manufactured by Intel, for executing operating instructions to carry out order handling steps as described herein. The processor 72 has access to memory 76, which may include ROM and RAM memory devices. The preferred embodiment of the system 18 includes a printer 78, a display device 74 such as an LCD monitor, and a user input device 83 such as a touch pad for receiving input commands from a user. In a preferred embodiment, the input device 83 is combined with the display device 74 in a touch-screen configuration. The system 18 preferably includes a hard drive 75 for storing a database, operational software and other data. In some embodiments, a barcode reader 80 is provided which is compatible with the POS computer system 22 of the retail establishment 15. The system 18 also preferably includes a POS interface 82 for communicating with the POS computer system 22.

The system 18 of FIG. 5 also includes a network interface card 84 for interfacing with a local area network (LAN), such as an Ethernet network. In the preferred embodiment of the invention, the site coordinator computer system 18 communicates with the reader units 16, the customer interface unit 20 and the communication network 24 via the network interface card 84. It will be appreciated that network communications between the components of the order handling system 14 in the retail establishment 15 may be via a wired or wireless network.

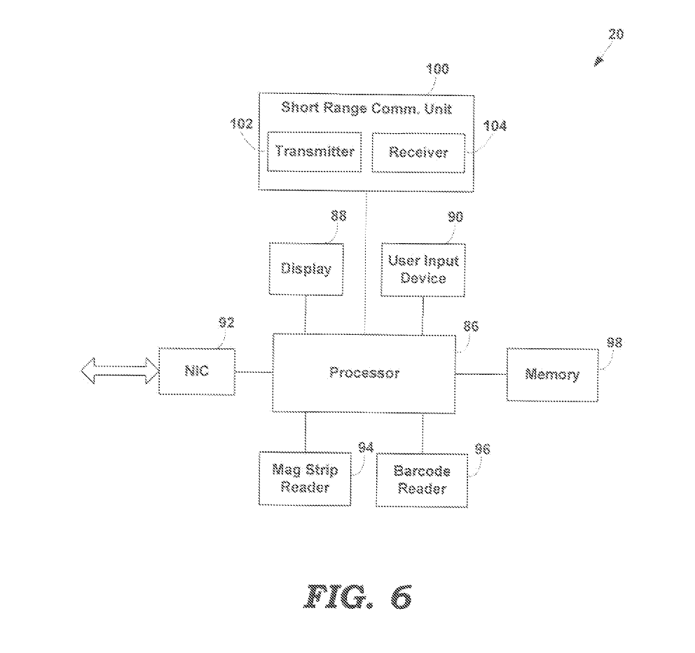

A preferred embodiment of the customer interface unit 20 is depicted in FIG. 6. All of the components of the customer interface unit 20 are preferably integrated into a single housing which may be positioned within an area of the retail establishment 15 that is accessible to customers. As described in more detail below, the customer interface unit 20 is provided for customers, who are also users of the tag units 12, to access their user account data stored on the central server system 26, to view and change their default order and to transfer funds into their monetary account associated with the order handling system 14.

The customer interface unit 20 preferably includes a short range communication unit 100, also referred to herein as a short range reader, for communicating wirelessly with the tag units 12. In the preferred embodiment, the short range reader 100 has all the functional communication capabilities of the reader unit 16, except its communication range is limited to no greater than about two meters. The preferred embodiment of the customer interface unit 20 also includes a processor 86, such as a model D Pentium 805 Dual Core 2.66 GHz processor manufactured by Intel, for executing operating instructions to carry out customer account access steps as described herein. The processor 86 has access to memory 98, which may include ROM and RAM memory devices. The preferred embodiment of the system 18 includes a display device 88, such as an LCD monitor, and a user input device 90, such as a touch pad, for receiving input commands from a user. In a preferred embodiment, the input device 90 is combined with the display device 88 in a touch-screen configuration. The customer interface unit 20 of FIG. 6 also includes a network interface card 92 for interfacing with the local area network (LAN) and with the wide area network 24. Preferred embodiments of the unit 20 include a magnetic strip reader 94, such as may be used to read the magnetic strip on a user's credit card, and a barcode reader 96 which may be used to read a barcode on a user account card, gift card or other identification or monetary card.

Prior to using a tag unit 12 for the first time in the proximity order processing system 10, the user creates a user account in the central server computer system 26. As part of the account creation process, the unit numbers stored in the memory of the tag unit 12 are entered into the database 30 to associate the user account with the particular tag unit 12. When the user creates an account, the user selects the retail establishments in which the tag unit 12 will be used. The unit numbers of the tag unit 12 are then associated with each of the retail establishments in the database 30. The user also enters a default order for each of the selected retail establishments. For example, the user may enter a large coffee with cream and sugar for the default order at a Starbucks coffee shop. During account creation, the user also sets up a monetary debit account to be used in paying for orders processed using the system 10. Further description of the account setup process is described hereinafter.

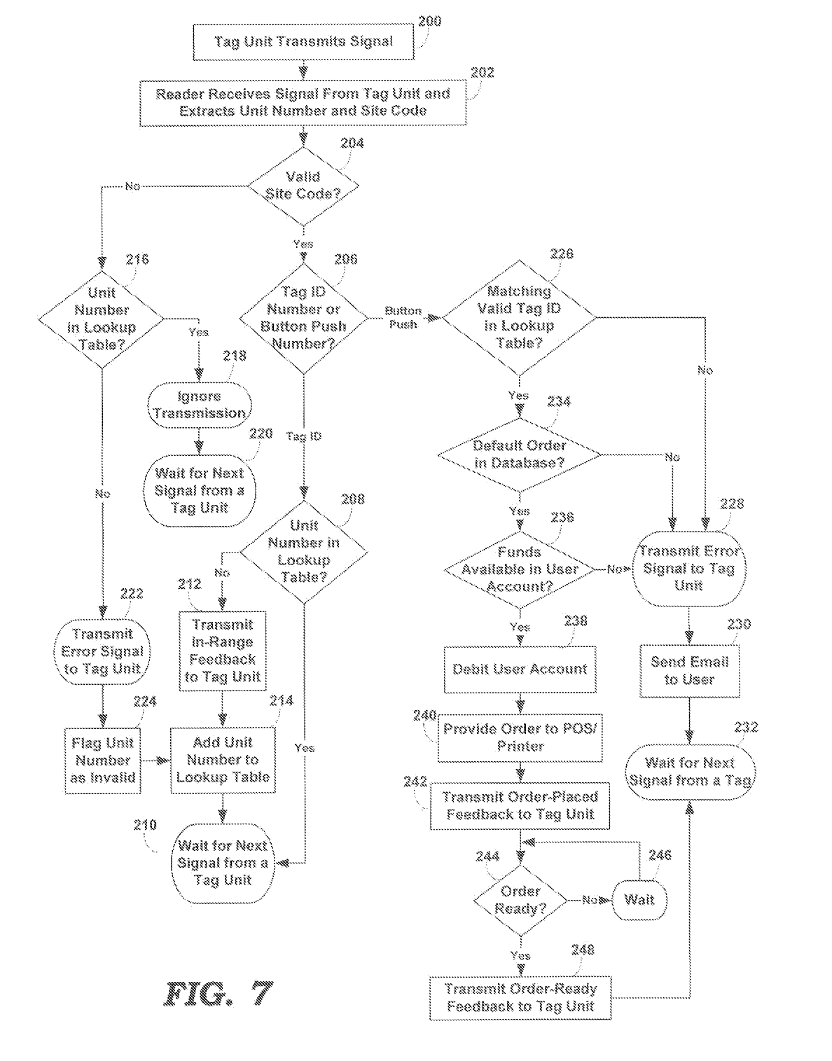

FIG. 7 depicts steps performed in processing communications between tag units 12 and the order handling system 14, and steps performed in handling a customer's order using the system 14. In describing the processing steps performed in the preferred embodiment of the invention, certain steps may be described as being performed by a reader unit 16, by the customer interface unit 20, by the site coordinator computer system 18 or by the central server system 26. However, it should be appreciated that in various embodiments the processing steps may be performed by any of the different processors within the overall system 14. Thus, the invention is not limited to any particular processing step being performed on any particular processor in the system 14.

With reference to FIG. 7, the process begins with wireless signals being transmitted from a tag unit 12. When a tag unit 12 is initially activated by a user, the unit 12 begins transmitting an RF unit identification signal containing a unit number string (step 200). In the preferred embodiment, the unit number string in a unit identification signal includes a unit identification number and a site code. The unit 12 preferably transmits the unit identification signal at a fixed interval of between about 1.5 and 5 seconds as determined by firmware residing in the memory 46 of the unit 12. In this regard, the tag unit 12 acts as an active RFID beacon, continuously transmitting its unit identification signal. When the button 36 on the tag unit 12 is pressed, the tag unit 12 stops transmitting the unit identification signal and begins transmitting an RF order confirmation signal which contains a unit number string. In the preferred embodiment, the unit number string in an order confirmation signal includes an order confirmation number and a site code. In the preferred embodiment, the order confirmation signal is transmitted continuously for as long as the button 36 is pressed.

In one embodiment of the invention, a single site code will be valid for all participating retail establishments 15. In another embodiment, specific site codes may be assigned to specific retail establishments. For example, a specific site code may be assigned to all Starbucks coffee shops, and special Starbucks-branded tag units 12 may be programmed with the Starbucks site code. In this example, the Starbucks tag units 12 will be operational only in Starbucks coffee shops.

When the unit 12 comes within communication range of a reader unit 16 (which is about 50 meters outdoors and about 15 meters indoors), the RF receiver 58 (FIG. 4) of the reader unit 16 receives the signal transmitted from the unit 12 and extracts the unit number string (step 202). As discussed above, the unit number string includes either a unit identification string if the received signal is a unit identification signal or an order confirmation string if the received signal is an order confirmation signal. The unit number string is transferred via the LAN to the site coordinator computer system 18 where the processor 72 (FIG. 5) determines whether the string includes a site code which is valid for the retail establishment 15 in which the reader unit 16 is disposed (step 204). In a preferred embodiment of the invention, the unit number string is provided to the central server computer system 26 via the communication network 24 where a query of the database 30 is performed to determine whether the site code for the particular tag unit 12 has been associated with the particular establishment 15. If the site code for the tag unit 12 is associated with the establishment in the database 30, the site code is determined to be valid.

If the site code is valid for the particular retail establishment (step 204), the processor 72 determines whether the unit number string contains a unit identification number or an order confirmation number (step 206). In a preferred embodiment of the invention, the unit identification string differs from the order confirmation string by one bit in the string, such as the highest-order bit. For example, the unit identification string for a particular tag unit 12 may be 012345689, and the order confirmation string for the same unit 12 may be 1123456780. If the processor 72 determines that the received signal contains a unit identification string, the processor 72 determines whether the unit identification string is currently listed in a lookup table (step 208) stored in the memory 76 or on the hard drive 75 of the site coordinator computer 18. If the unit identification string is in the lookup table, the system 18 does not process this string further, but rather waits for the next received signal from any unit 12 (step 210). If the unit identification string is not in the lookup table, this indicates that the string being currently processed is the first such string received from the identified tag unit 12. In this case, the processor 72 sends an instruction to the reader unit 16 to transmit an in-range feedback signal to the tag unit 12 which transmitted the identification string (step 212). In the preferred embodiment, an in-range feedback signal contains a particular flag that identifies it as an in-range signal. After transmission of the in-range feedback signal (step 212), the processor 72 adds the unit identification string to the lookup table (step 214) and waits for the next received signal from any tag unit 12 (step 210).

To “target” a feedback signal for a particular tag unit 12, the reader unit 16 transmits a string that includes the unique unit identification number of the targeted tag unit 12. Since all tag units 12 have a unique identification number, a tag unit 12 can “filter out” any transmissions it receives that do not include its identification number. As shown in the process flow of FIG. 8, when the tag units 12 are not transmitting signals, they are “listening” for feedback signal transmissions from reader units 16 (step 300). When a tag unit 12 receives a feedback signal (step 302), the processor 44 (FIG. 2) extracts the unit identification number contained therein (step 304). If the unit identification number extracted from the received signal matches the unit identification number stored in the memory 46 of the tag unit 12 (step 306), the processor 44 proceeds through a series of steps to determine what type of feedback signal has been received and to activate the user feedback device 38 accordingly. If the unit identification number extracted from the received signal does not match the unit identification string stored in the memory 46 of the tag unit 12 (step 306), the unit 12 ignores the received signal (step 308) (which means it takes no action with regard to the received signal), and the tag unit 12 “listens” for another feedback signal (step 300).

In the case of the in-range feedback signal transmitted at step 212 of FIG. 7, the processor 44 of the “targeted” tag unit 12 will determine, based on the flag extracted from the feedback signal, that the feedback signal is not an error signal (step 310) and is an in-range feedback signal (step 314). In this case, the processor 44 activates the user feedback device 38 to indicate an in-range condition (step 316). In the preferred embodiment of the invention, this step involves causing the purple LED 38b to pulse on and off. The tag unit 12 then “listens” for another feedback signal (step 300).

With reference again to FIG. 7, if it is determined that the site code contained in the received unit number string is not valid, the processor 72 determines whether the unit number in the identification string is currently listed in a lookup table (step 216). If it is already listed, this means a previous transmission from this invalid tag unit 12 was received and logged. In this case, the system 18 ignores the received signal (step 218) and the reader units 16 “listen” for another signal transmitted from a tag unit 12 (step 220).

If it is determined that the unit number in the identification string is not currently listed in the lookup table (step 216), the processor 72 sends an instruction to the reader unit 16 to transmit an error feedback signal to the unit 12 which transmitted the identification string (step 222). In the preferred embodiment, an error feedback signal contains a particular flag that identifies it as an error signal. After transmission of the error feedback signal (step 222), the processor 72 flags the unit number as invalid (step 224), adds the unit number to the lookup table (step 214) and waits for the next received signal from any unit 12 (step 210).

With reference to FIG. 8, when the tag unit 12 receives an error feedback signal transmitted from a reader unit 16, the processor 44 of the tag unit 12 will determine, based on the flag extracted from the feedback signal, that the feedback signal is an error signal (step 310). In this case, the processor 44 activates the user feedback device 38 to indicate an error condition (step 312). In the preferred embodiment of the invention, this step involves activating the red LED 38c to be in a continuous on state (not flashing). The tag unit 12 then “listens” for another feedback signal (step 300).

If it is determined at step 206 that the unit number string contains an order confirmation number (indicating a button push), the processor 72 determines whether a valid matching unit number is listed in the lookup table (step 226). If no valid matching unit number is in the lookup table, the processor 72 sends an instruction to the reader unit 16 to transmit an error feedback signal to the unit 12 which transmitted the order confirmation string (step 228). In this situation, the processor 72 also sends a request to the central server computer system 26 to send an email to the user indicating that an error condition was encountered during the processing of the user's order (step 230). This email is sent to an email address associated with the unit number in the database 30. The processor 72 then waits for the next signal from any tag unit 12 (step 232).

If it is determined at step 226 that a valid matching unit number is listed in the lookup table (step 226), the site coordinator computer system 18 communicates via the communication network 24 with the central server computer system 26 (FIG. 1) to request a series of database queries regarding the customer account associated with the unit number. The first query is whether there is a default order stored in the database 30 in association with the unit number (step 234). If there is no default order on file, a negative indication is sent back to the site coordinator computer system 18 via the network 24, and an error signal is transmitted from the reader unit 16 to the tag unit 12 (step 228). In this situation, the central server computer system 26 also sends an email to the user indicating that a no-default-order error condition was encountered during the processing of the user's order (step 230). The processor 72 then waits for the next signal from any tag unit 12 (step 232).

If it is determined at step 234 that there is a default order stored in the database 30 in association with the unit number, the central server computer system 26 queries the database 30 to determine whether there are sufficient funds to pay for the default order in a monetary account associated with the unit number (step 236). If there are not sufficient funds, a negative indication is sent back to the site coordinator computer system 18 via the network 24, and an error signal is transmitted from the reader unit 16 to the tag unit 12 (step 228). The central server computer system 26 also sends an email to the user indicating that an insufficient-funds error condition was encountered during the processing of the user's order (step 230). The processor 72 then waits for the next signal from any tag unit 12 (step 232).

If the user of the tag unit 12 wishes to resolve an error condition or take care of any other business related to the user's account while the user is at the retail establishment 15, the user may access the user's account using the customer interface unit 20. In the preferred embodiment, when the user brings the tag unit 12 within a few feet of the customer interface unit 20, the receiver 104 of the short range communication unit 100 picks up the RF unit identification signal being transmitted from the tag unit 12. The processor 86 of the customer interface unit 20 extracts the unit number from the unit identification signal and sends a message string containing the unit number to the central server computer system 26 via the communication network 24. The central server computer system 26 performs a query of the database 30 to determine the account information associated with the unit number. The central server computer system 26 then opens a communication session with the customer interface unit 20, such as using Hypertext Markup Language (HTML) protocol, whereby the user may edit the user's account information and/or transfer funds into the user's monetary account. This communication session is preferably conducted via the web site server 34 of the central server computer system 26, in such a manner that the web pages presented via the customer interface unit 20 appear exactly the same as if the user were accessing the user's account via the communication network 24 using the user's personal computer 25. Further discussion of the user access to the web site 34 is provided hereinafter.

With reference again to FIG. 7, if it is determined at step 236 that there are sufficient funds in the user's account, the finance handler 28 of the central server computer system 26 debits the user's account by the amount needed to pay for the default order (step 238) and the amount of the remaining balance in the user's account is updated in the database 30. The central server computer system 26 then sends a order confirmation message via the communication network 24 to the site coordinator computer system 18. Based on the order confirmation message, the processor 72 of the site coordinator computer system 18 communicates the order via the POS interface 82 to the POS system 22 of the retail establishment 15 (step 240). The POS system 22 then processes the user's order according to the normal order processing procedures of the retail establishment 15. If the retail establishment 15 does not implement a POS computer system 22, then the processor 72 provides the order information to the printer 78 where it may be accessed by employees of the retail establishment 15.

Once the order has been communicated to the POS system 22, the processor 72 sends an instruction to the reader unit 16 to transmit an order-placed feedback signal to the tag unit 12 which transmitted the identification string (step 242). In the preferred embodiment, an order-placed feedback signal contains a particular flag that identifies it as an order-placed feedback signal. In the case of the order-placed feedback signal transmitted at step 242 of FIG. 7, the processor 44 of the “targeted” tag unit 12 will determine, based on the flag extracted from the feedback signal, that the feedback signal is not an error signal (step 310 in FIG. 8), not an in-range feedback signal (step 314) and is an order-placed feedback signal (step 318). In this case, the processor 44 activates the user feedback device 38 to indicate an order-placed condition (step 320). In the preferred embodiment of the invention, this step involves causing the green LED 38a to be in a solid (non-pulsing) on state. The tag unit 12 then “listens” for another feedback signal (step 300).

With reference to FIG. 7, when the user's order is ready for pickup (step 244), the processor 72 sends an instruction to the reader unit 16 to transmit an order-ready feedback signal to the tag unit 12 which transmitted the identification string (step 248). In the preferred embodiment, an order-ready feedback signal contains a particular flag that identifies it as an order-ready feedback signal. With reference to FIG. 8, upon receipt of an order-ready feedback signal transmitted at step 248 of FIG. 7, the processor 44 of the “targeted” tag unit 12 will determine, based on the flag extracted from the feedback signal, that the feedback signal is not an error signal (step 310), not an in-range feedback signal (step 314), not an order-placed feedback signal (step 318), and is an order-ready feedback signal (step 322). In this case, the processor 44 activates the user feedback device 38 to indicate an order-ready condition (step 324). In the preferred embodiment of the invention, this step involves causing the green LED 38a to pulse on and off. The tag unit 12 then “listens” for another feedback signal (step 300).

It will be appreciated that the order handling system 14 described herein is capable of communicating with and processing signals from many tag units 12 simultaneously. Thus, many unit numbers from many tag units 12 may be listed in the lookup table on the site coordinator computer system 18 at any given time. In this regard, the process steps 210, 220 and 232 (“Wait for Next Signal from a Tag”) of FIG. 7 indicate that the system 14 is waiting to receive and process unit identification signals from any tag unit 12 within communication range of the reader units 16. In a preferred embodiment, unit identification numbers are removed from the lookup table when no transmission has been received from the associated tag unit 12 for 30 minutes or more. This “time-out” value may preferably be reprogrammed at the site coordinator computer system 18.

It should also be appreciated that many site coordinator computer systems 18 and customer interface units 20 at retail establishments 15 the world over may be in communication with the central server computer system 26 at any given time.

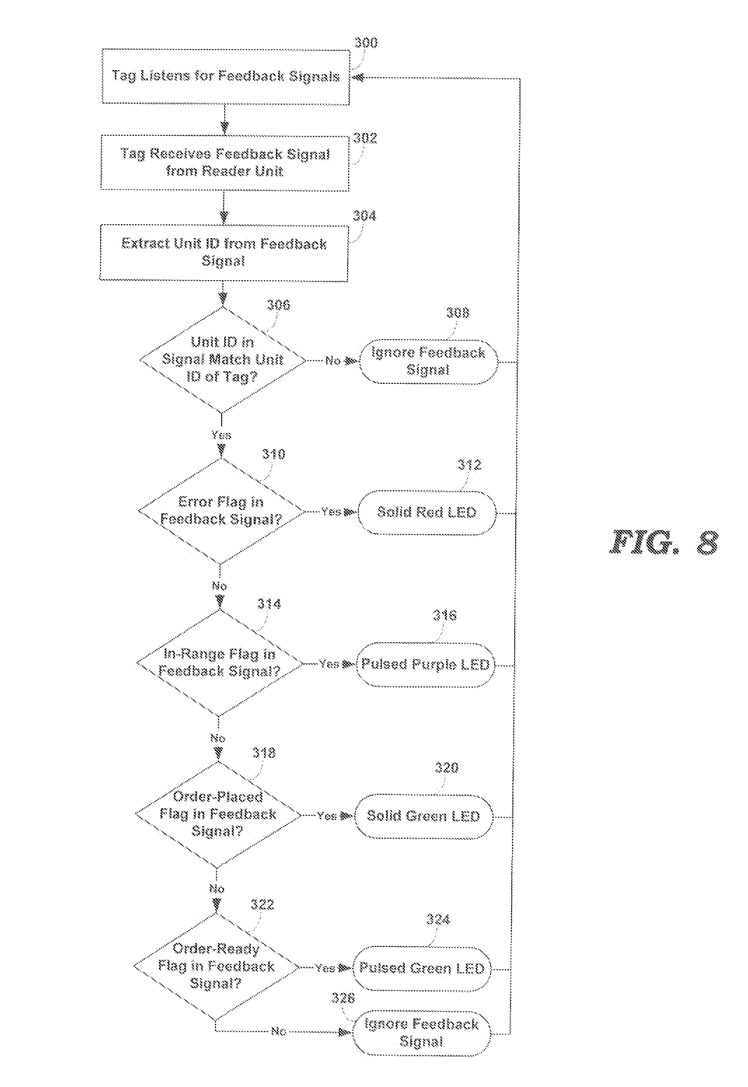

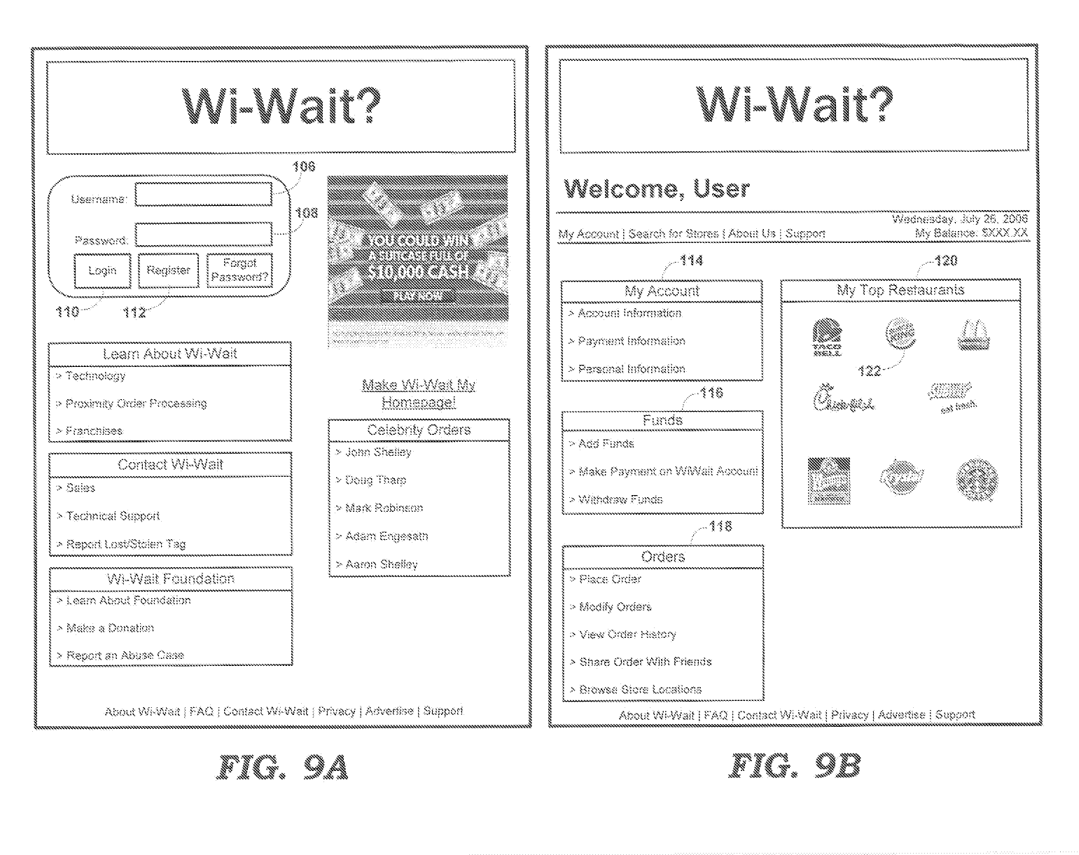

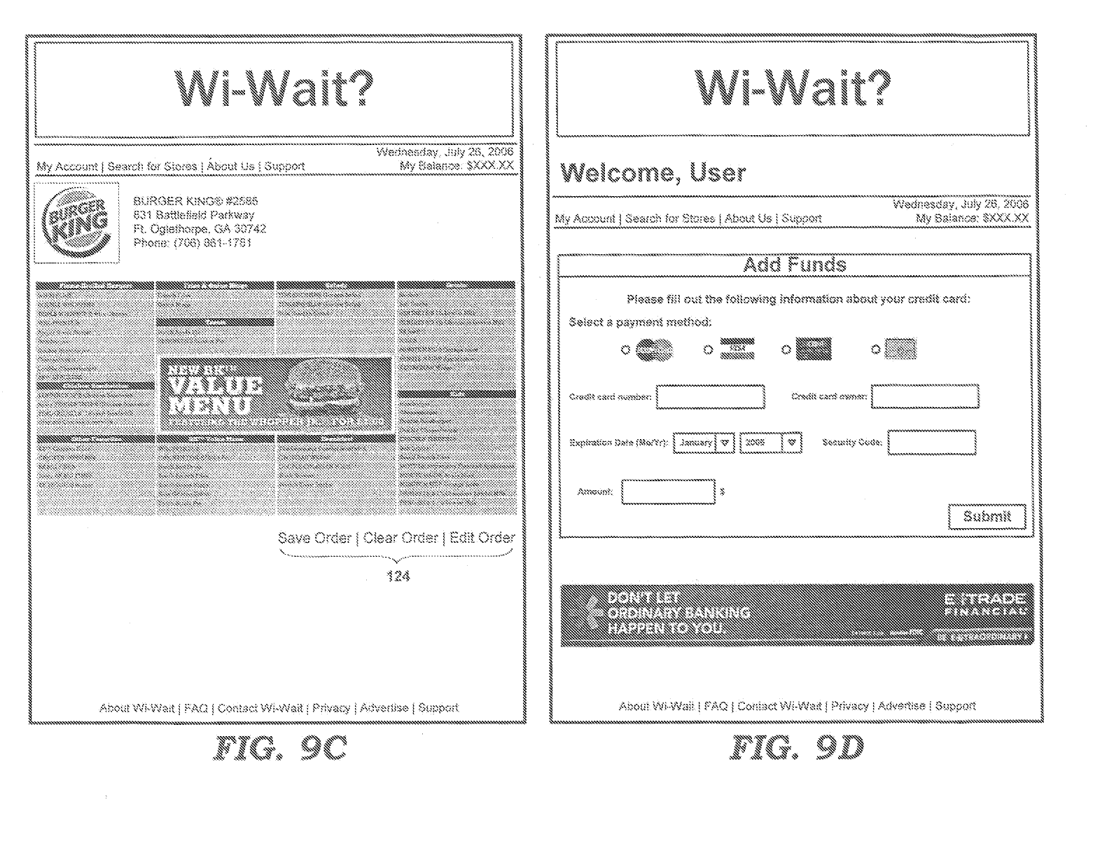

FIGS. 9A-9D depict web pages generated by the web site server 34 of a preferred embodiment of the invention. These figures provide examples of what a user may see when accessing the web site server 34 via the user's personal computer 25 or via the customer interface unit 20. FIG. 9A depicts a log-in web page wherein the user may enter a username in a username field 106 and a password in a password field 108 to gain access to the user's account stored on the central server computer system 26. If the user has not yet registered the user's tag unit 12, the user may click on the “Register” button 112 to be presented a page wherein the user may enter the number of the tag unit 12 and the user's information. Once logged in, the user is presented with a page as depicted in FIG. 9B, which provides links to the user's account 114, funds 116 and orders 118. The window 120 indicates the retail establishments for which the tag unit 12 is currently activated. When the user clicks on a logo icon in the window 120, such as the Burger King icon 122, a menu page such as depicted in FIG. 9C is displayed. Using the menu page, a user may view items that may be included in the user's default order. In the example of FIG. 9C, the user may edit and save a default order for Burger King using the links 124. Referring again to FIG. 9B, if the user clicks on the “Add Funds” link 126, a page such as depicted in FIG. 9D is displayed. Using this page, the user may provide credit card information and specify a dollar amount to be transferred from the credit card to the user's debit account.

It will be appreciated that the web pages represented in FIGS. 9A-9D are merely exemplary of an interface used to access the user's account information. In other embodiments, the user may access the account information via telephone.

Preferred embodiments of the invention are applicable for use in various retail establishments that provide goods or services. For example, the retail establishment 15 may be a restaurant, coffee shop, pharmacy, grocery store, golf course, airport or retail store.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A proximity order processing system comprising:
a wireless portable communication unit having:
a memory device for storing unit information;
a communication unit transmitter for transmitting an order confirmation signal that contains the unit information; and
an order confirmation input device operable by a user to initiate transmission of the order confirmation signal by the communication unit transmitter; and
an order handling system comprising:
one or more order handling receivers for receiving the order confirmation signal containing the unit information;
a database that associates unit information with default order information;
one or more computer processors for operating on the database to access default order information associated with the unit information contained in the order confirmation signal; and
an order placement interface for communicating the default order information to an order placement apparatus associated with an order fulfillment establishment.

2. The system of claim 1 wherein the wireless portable communication unit comprises a radio frequency identification (RFID) unit.

3. The system of claim 1 wherein the memory device of the wireless portable communication unit stores the unit information including unit identification information and order confirmation information.

4. The system of claim 1 wherein
the wireless portable communication unit further comprises:
a communication unit receiver for receiving user feedback signals from the order handling system; and
a user feedback device for communicating user feedback to a user of the wireless portable communication unit, wherein the user feedback is based on one or more characteristics of the user feedback signals, and
the order handling system further comprises one or more order handling transmitters for transmitting the user feedback signals.

5. The system of claim 4 wherein the user feedback device comprises one or more light emitting diodes.

6. The system of claim 4 wherein
the one or more order handling transmitters are for transmitting the user feedback signals including an in-range feedback signal to indicate when the communication unit transmitter is in communication range of the one or more order handling receivers,
the communication unit receiver is for receiving the in-range feedback signal, and
the user feedback device is for communicating user feedback indicating that the communication unit transmitter is in communication range of the one or more order handling receivers based on receipt of the in-range feedback signal.

7. The system of claim 4 wherein
the one or more order handling transmitters are for transmitting the user feedback signals including an order-placed feedback signal to indicate when the default order information has been provided to the order placement apparatus,
the communication unit receiver is for receiving the order-placed feedback signal, and
the user feedback device is for communicating user feedback indicating that the default order information has been provided to the order placement apparatus based on receipt of the order-placed feedback signal.

8. The system of claim 4 wherein
the one or more order handling transmitters are for transmitting the user feedback signals including an order-ready feedback signal to indicate when the user's default order is ready for pickup at the order fulfillment establishment,
the communication unit receiver is for receiving the order-ready feedback signal, and
the user feedback device is for communicating user feedback indicating that the user's default order is ready for pickup at the order fulfillment establishment based on receipt of the order-ready feedback signal.

9. The system of claim 4 wherein
the one or more order handling transmitters are for transmitting the user feedback signals including an error feedback signal to indicate when an error has occurred during processing of the user's default order,
the communication unit receiver is for receiving the error feedback signal, and
the user feedback device is for communicating user feedback indicating that an error has occurred during processing of the user's default order based on receipt of the error feedback signal.

10. The system of claim 4 wherein
the one or more order handling transmitters transmit user feedback signals containing unit identification information that identifies the wireless portable communication unit, and
the user feedback device communicates user feedback to the user of the wireless portable communication unit only when the unit identification information contained in the user feedback signals corresponds to unit information stored in the memory device of the wireless portable communication unit.

11. The system of claim 1 wherein the order confirmation input device comprises a push button operable by a user of the wireless portable communication unit.

12. The system of claim 1 wherein
the communication unit transmitter periodically transmits an identification signal that includes unit identification information,
the one or more order handling receivers receive the identification signal when the communication unit transmitter is within communication range of the one or more order handling receivers, and
the order handling system includes one or more order handling transmitters for transmitting an in-range feedback signal to indicate when the communication unit transmitter is in communication range of the one or more order handling receivers.

13. The system of claim 1 wherein the one or more order handling receivers are disposed in the order fulfillment establishment.

14. The system of claim 1 wherein the database is located remotely from the order fulfillment establishment, and the one or more computer processors submit database queries via a communication network.

15. The system of claim 1 wherein the order handling system includes a customer interface unit disposed within the order fulfillment establishment, the customer interface unit comprising:
a short-range communication unit for providing wireless communication between the customer interface unit and the wireless portable communication unit when the wireless portable communication unit is disposed adjacent the customer interface unit;
a display device for displaying user account information to a user of the customer interface unit;
a user interface device for receiving user input to control operations of the customer interface unit; and
a network interface device for providing communication with the one or more computer processors of the order handling system via a network communication link

16. The system of claim 15 wherein the short-range communication unit provides wireless communication between the customer interface unit and the wireless portable communication unit when the wireless portable communication unit is within about 2 meters of the customer interface unit.

17. The system of claim 1 wherein at least one of the one or more processors of the order handling system extracts payment for the default order from a customer monetary account upon receipt of the order confirmation signal transmitted from the wireless portable communication unit.

18. The system of claim 1 wherein the order fulfillment establishment is a fast food restaurant.

19. The system of claim 1 wherein the order fulfillment establishment is a pharmacy.

20. A wireless portable communication unit for use in conjunction with a proximity order handling system, the wireless portable communication unit comprising:
a memory device for storing unit identification information and order confirmation information;
a communication unit transmitter for automatically transmitting an identification signal at periodic time intervals, the identification signal containing the identification information, and for transmitting a order confirmation signal when manually activated to do so, the order confirmation signal containing the order confirmation information;
an order confirmation input device operable by a user to initiate transmission of the order confirmation signal from the communication unit transmitter;
a communication unit receiver for receiving user feedback signals transmitted from the proximity order handling system; and
a user feedback device for communicating user feedback to the user of the wireless portable communication unit, wherein the user feedback is based on one or more characteristics of the user feedback signals.

21. The wireless portable communication unit of claim 20 comprising a radio frequency identification (RFID) unit.

22. The wireless portable communication unit of claim 20 wherein the user feedback device comprises one or more light emitting diodes.

23. The wireless portable communication unit of claim 20 wherein the user feedback device comprises an LCD display screen.

24. The wireless portable communication unit of claim 20 wherein
the communication unit receiver is operable to receive an in-range feedback signal transmitted from the proximity order handling system, and
the user feedback device is operable to communicate user feedback indicating that the communication unit transmitter is in communication range of the proximity order handling system based on receipt of the in-range feedback signal.

25. The wireless portable communication unit of claim 20 wherein
the communication unit receiver is operable to receive an order-placed feedback signal transmitted from the proximity order handling system, and
the user feedback device is operable to communicate user feedback indicating that user default order information has been provided to an order placement apparatus based on receipt of the order-placed feedback signal.

26. The wireless portable communication unit of claim 20 wherein
the communication unit receiver is operable to receive an order-ready feedback signal transmitted from the proximity order handling system, and
the user feedback device is operable to communicate user feedback indicating that a user's default order is ready for pickup at an order fulfillment establishment based on receipt of the order-ready feedback signal.

27. The wireless portable communication unit of claim 20 wherein
the communication unit receiver is operable to receive an error feedback signal transmitted from the proximity order handling system, and
the user feedback device is operable to communicate user feedback indicating that an error has occurred during processing of a user's default order based on receipt of the error feedback signal.

28. The wireless portable communication unit of claim 20 wherein the user feedback device communicates user feedback to the user of the wireless portable communication unit only when unit identification information contained in the user feedback signals corresponds to unit identification information stored in the memory device of the wireless portable communication unit.

29. The wireless portable communication unit of claim 20 wherein the order confirmation input device comprises a push button operable by a user of the wireless portable communication unit.

30. The wireless portable communication unit of claim 20 housed in a key fob housing.

31. The wireless portable communication unit of claim 20 housed in a cellular telephone housing.

32. A method for placing a predetermined order for goods or services using a portable wireless communication unit, wherein the goods or services are to be provided by an order fulfillment establishment, the method comprising:
(a) operating a user input device on the portable wireless communication unit to initiate transmission of an order confirmation signal containing order confirmation information;
(b) transmitting the order confirmation signal from the portable wireless communication unit;
(c) receiving the order confirmation signal at a reader unit associated with the retail establishment;
(d) extracting the order confirmation information from the order confirmation signal received by the reader unit;
(e) determining the predetermined order based at least in part on the order confirmation information extracted from the order confirmation signal; and
(f) communicating the predetermined order to an order placement apparatus associated with the order fulfillment establishment.

33. The method of claim 32 further comprising:
(g) automatically transmitting a unit identification signal from the portable wireless communication unit at periodic time intervals, the unit identification signal containing unit identification information;
(h) receiving the unit identification signal at the reader unit associated with the order fulfillment establishment; and
(i) extracting unit identification information from the unit identification signal received by the reader unit.

34. The method of claim 32 further comprising:
(g) determining whether the order confirmation information is associated with registration information stored in a central database, where the registration information identifies the portable wireless communication unit; and
(h) communicating the predetermined order to the order placement apparatus only if the order confirmation information is associated with the registration information stored in the central database.

35. The method of claim 32 further comprising:
(g) transmitting a feedback signal from the reader unit to the portable wireless communication unit, where the feedback signal contains feedback information related to status of the order; and
(h) activating a user feedback device on the portable wireless communication unit based on the feedback information to provide feedback to a user of the portable wireless communication unit regarding the status of the order.

36. The method of claim 32 further comprising:
(g) accessing a web page via a communication network to enter registration information in a central database, where the registration information identifies the portable wireless communication unit; and
(h) accessing a web page via the communication network to enter the predetermined order in the central database in association with the registration information,
wherein step (e) further comprises accessing the central database to determine the predetermined order.
